(19) United States
(12) Patent Application Publication
(10) Pub. No.: US 2026/0292857 A1
(43) Pub. Date: Sep. 24, 2026

(54) METHOD FOR FORWARDING BROADCAST STREAMS AND ASSOCIATED ELECTRONIC DEVICE

(71) Applicant: MediaTek Singapore Pte. Ltd., Singapore (SG)

(72) Inventors: Biwei Che, Chengdu (CN); Hongwei Du, Chengdu (CN); Subin Ai, Chengdu (CN)

(73) Assignee: MediaTek Singapore Pte. Ltd., Singapore (SG)

(21) Appl. No.: 19/363,670

(22) Filed: Oct. 21, 2025

(30) Foreign Application Priority Data
Mar. 18, 2025 (CN) 202510324226.5

(51) Int. Cl. H04W 72/30; H04W 40/24; H04W 48/10

(52) U.S. Cl. CPC H04W 72/30; H04W 40/24; H04W 48/10

(57) ABSTRACT

A method for forwarding broadcast streams by an electronic device comprises: receiving at least one of an extended advertising (EA) packet, an EA auxiliary packet, a periodic advertising (PA) packet, and broadcast isochronous streams (BISs) of a broadcast transmission, wherein the broadcast transmission comprises the EA packet, the EA auxiliary packet, the PA packet, and the BISs; and the BISs carry the broadcast streams; determining whether the broadcast streams need to be forwarded based on at least one of the EA packet, the EA auxiliary packet, and the PA packet; and in response to the broadcast streams needing to be forwarded, transmitting an intermediate broadcast transmission according to the broadcast transmission, wherein the intermediate broadcast transmission comprises an intermediate EA packet, an intermediate EA auxiliary packet, an intermediate PA packet, and intermediate BISs carrying the broadcast streams.

### BACKGROUND

The present invention is related to broadcast audio technology, and more particularly, to a method for forwarding audio broadcast streams, and an associated electronic device.

For an existing Bluetooth audio broadcast method, only a single audio source device transmits Bluetooth low energy (BLE)-based broadcast streams over the air for scanning and reception by multiple reception devices within a broadcast range. When the audio source device has a limited power, however, the broadcast range may not meet the requirements of certain broadcast applications.

### SUMMARY

It is therefore one of the objectives of the present invention to provide a method for forwarding an audio broadcast packet and an associated electronic device, in order to address the above-mentioned issues.

According to an embodiment of the present invention, a method for forwarding broadcast streams by an electronic device is provided. The method includes: receiving at least one of an extended advertising (EA) packet, an EA auxiliary packet, a periodic advertising (PA) packet, and broadcast isochronous streams (BISs) of a broadcast transmission, wherein the broadcast transmission comprises the EA packet, the EA auxiliary packet, the PA packet, and the BISs; and the BISs carry the broadcast streams; determining whether the broadcast streams need to be forwarded based on at least one of the EA packet, the EA auxiliary packet, and the PA packet; and in response to the broadcast streams needing to be forwarded, transmitting an intermediate broadcast transmission according to the broadcast transmission, wherein the intermediate broadcast transmission comprises an intermediate EA packet, an intermediate EA auxiliary packet, an intermediate PA packet, and intermediate BISs carrying the broadcast streams.

According to an embodiment of the present invention, an electronic device is provided, wherein the electronic device includes a wireless communication module and a processor. The wireless communication module is arranged to perform a scanning operation to receive at least one of an EA packet, an EA auxiliary packet, a PA packet, and the broadcast streams of a broadcast transmission, wherein the broadcast transmission comprises the EA packet, the EA auxiliary packet, the PA packet, and the broadcast streams. The processor is arranged to: determine whether the broadcast streams need to be forwarded based on at least one of the EA packet, the EA auxiliary packet, and the PA packet; wherein in response to the broadcast streams needing to be forwarded, the wireless communication module is further arranged to transmit an intermediate broadcast transmission according to the broadcast transmission; and the intermediate broadcast transmission comprises an intermediate EA packet, an intermediate EA auxiliary packet, an intermediate PA packet, and the broadcast streams.

One of the benefits of the present invention is that, for the electronic device of the present invention acting as both the BMS and BMR (e.g., an intermediate audio device), the electronic device may relay the received audio broadcast transmission. Further, the wireless communication module (e.g., the BT controller) in the electronic device can directly forward the audio data of the received audio broadcast transmission without sending the audio data to the host and then forwarding the audio data from the host, which can greatly improve a latency of forwarding the audio broadcast streams.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating internal layer architecture of an audio broadcast packet according to an embodiment of the present invention.

FIG. 3 is a diagram illustrating an example of broadcasting an audio broadcast transmission via an audio source device and multiple intermediate audio devices according to an embodiment of the present invention.

FIG. 4 is a diagram illustrating multiple broadcast ranges of an audio source device and multiple intermediate audio devices according to an embodiment of the present invention.

FIGS. 5 and 6 illustrate a flow chart of an intermediate audio device determining to relay the audio broadcast transmission and receiving the audio broadcast transmission, respectively, according to an embodiment of the present invention.

FIGS. 7A and 7B illustrate an intermediate audio device forwarding audio broadcast streams, respectively, according to an embodiment of the present invention.

FIG. 8 illustrates a flow chart of an intermediate audio device forwarding audio broadcast streams according to an embodiment of the present invention.

FIG. 9 is a flow chart of a method for forwarding broadcast streams by an electronic device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms "include" and "comprise" are used in an open-ended fashion, and thus should be interpreted to mean "include, but not limited to ...".

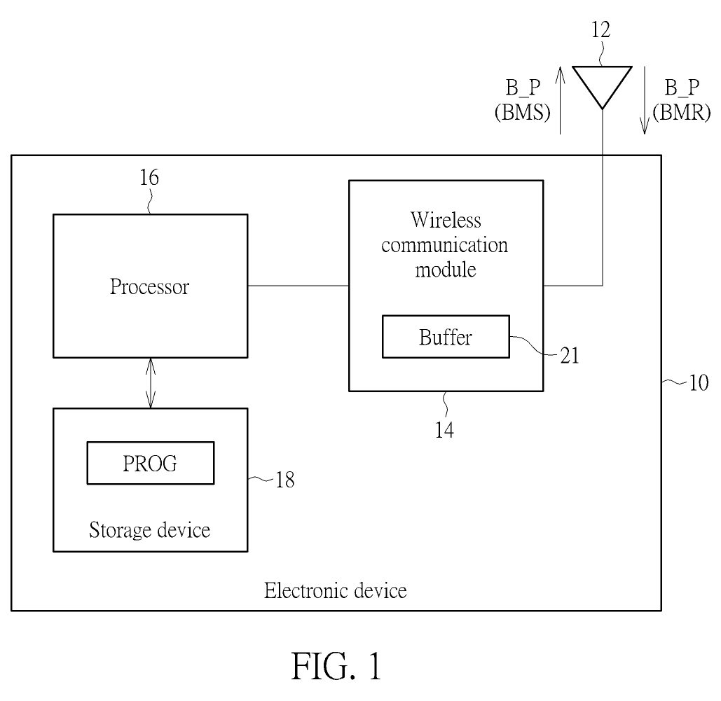

FIG. 1 is a diagram illustrating an electronic device 10 according to an embodiment of the present invention. Examples of the electronic device 10 may include, but are not limited to: a multifunctional mobile phone and a wearable device. As shown in FIG. 1, the electronic device 10 may include an antenna 12, a wireless communication module 14, a processor 16, and a storage device 18. The electronic device 10 may comply with version 5.2 or above of the Bluetooth communication standard formulated by the Bluetooth Special Interest Group (SIG). Therefore, the electronic device 10 can support a Bluetooth broadcast audio function (e.g., an Auracast broadcast audio function). That is, under a situation that the electronic device 10 acts as a broadcast media sender (BMS), an audio broadcast transmission B_P can be transmitted over the air by the wireless communication module 14 to an unlimited number of reception devices, wherein each reception device acts as a broadcast media receiver (BMR). In addition, under a situation that the electronic device 10 acts as the BMR, the wireless communication module 14 in the electronic device 10 may perform a scanning operation to detect whether there is a receivable audio broadcast transmission from other device.

It should be noted that, if the electronic device 10 acts as both the BMS and the BMR, the electronic device 10 may be an intermediate audio device. For example, after the audio broadcast transmission B_P is received from other device, the electronic device 10 may be further arranged to transmit an intermediate audio broadcast transmission in order to increase a propagation distance of contents in the audio broadcast transmission B_P.

The wireless communication module 14 may conform to a specification of a link layer (LL) protocol, wherein the wireless communication module 14 may be implemented via firmware, and a buffer 21 is included in the wireless communication module 14. The processor 16 may be referred to as a host and may be a single-core processor or a multi-core processor. The storage device 18 is a non-transitory machine-readable medium, and is arranged to store computer program code PROG. The processor 16 is equipped with software execution capability. The processor 16 and the wireless communication module 14 performs a method for forwarding audio broadcast streams of the audio broadcast transmission B_P as proposed by the present invention. The electronic device 10 may be regarded as a computer system using a computer program product that includes a computer-readable medium containing the computer program code PROG. That is, the method of the present invention may be embodied on the electronic device 10.

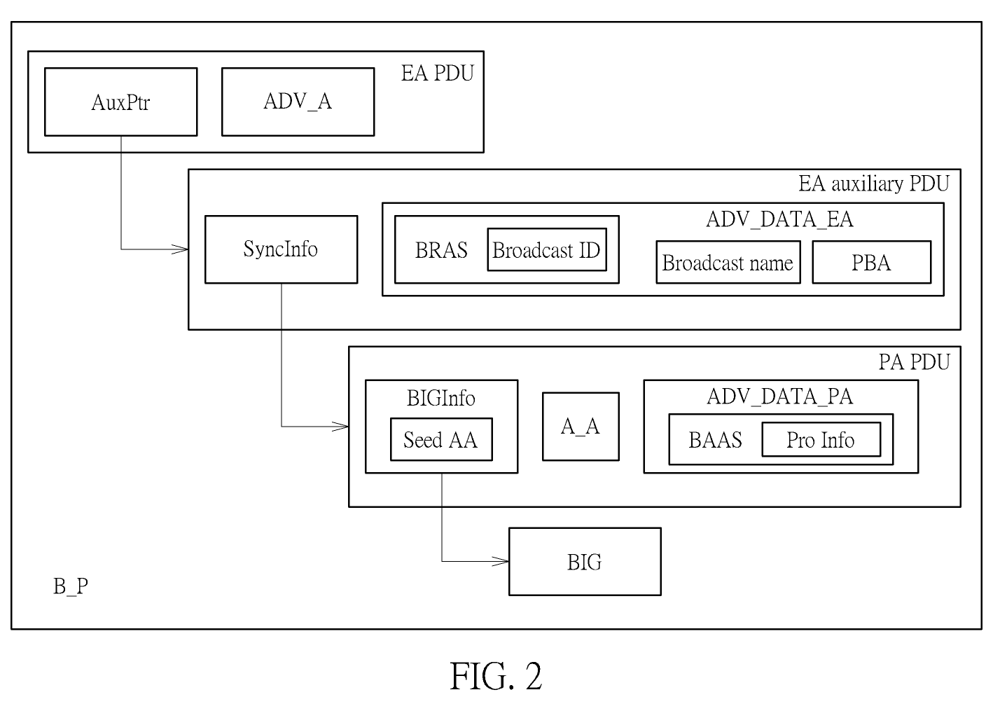

FIG. 2 is a diagram illustrating layer architecture of the audio broadcast transmission B_P according to an embodiment of the present invention. The one or more broadcast audio streams are transmitted by a Broadcast sender and are transported by using broadcast isochronous streams (BISes) within a broadcast isochronous group (BIG). For transmitting the broadcast audio streams, the broadcast sender also transmit an extended advertising (EA) packet and periodic advertising (PA) packets. As shown in FIG. 2, the audio broadcast transmission B_P has four-layer architecture, such as a first layer FL, a second layer SL, a third layer TL, and a fourth layer FOL. The first layer FL comprises EA protocol data unit (PDU), the second layer SL comprises EA auxiliary PDU, the third layer TL comprises PA PDU, and the fourth FOL comprises BIG.

Through a primary advertising channel, the EA PDU may be transmitted, wherein the EA PDU may include an AuxPtr field (labeled as “AuxPtr” in FIG. 2) and an advertising address ADV_A, the AuxPtr field contains information for helping a scanning device to perform a synchronization reception to the EA auxiliary PDU, and the advertising address ADV_A may indicate a device address of a sender sending the EA advertising PDU. For example, the scanning device may receive the EA auxiliary PDU at a time point determined based on the AuxPtr field.

The second layer SL comprises an EA auxiliary PDU. The EA auxiliary PDU may include a SyncInfo field (labeled as “SyncInfo” in FIG. 2) and advertising data ADV_DATA_EA. The advertising data ADV_DATA_EA in the EA auxiliary PDU may include a broadcast audio announcement service (labeled as “BRAS” in FIG. 2), a broadcast name, and a Public Broadcast Announcement (PBA), wherein the broadcast audio announcement service includes a broadcast ID, and the broadcast ID is used for the scanning device to find the broadcast audio streams. The broadcast ID may identify the broadcast audio stream. The broadcast name may indicate the name of the sender. The broadcast name may be a human readable string. The SyncInfo field may contain information for helping the scanning device to perform a synchronization reception to a PA PDU. For example, the scanning device may receive the PA PDU at a time point determined based on the SyncInfo field. The EA auxiliary PDU may be transmitted via one or more general-purpose channels.

The third layer TL comprises the PA PDU. The PA PDU may be an auxiliary synchronization PDU. The PA PDU may include a BIGInfo field (labeled as “BIGInfo” in FIG. 2), an access address A_A, and advertising data ADV_DATA_PA, wherein the access address A_A may indicate a train of periodically transmitted auxiliary synchronization PDUs. The advertising data ADV_DATA_PA may include a basic audio announcement service (labeled as “BAAS” in FIG. 2), wherein the basic audio announcement service may include parameters of the broadcast audio streams and program information (labeled as “Pro Info” in FIG. 2), and the parameters of the broadcast audio streams may include Codec parameters and the number of BISes. The BIGInfo field includes information for helping the scanning device to performing a synchronization reception to a BIG. The program information indicates content of the broadcast streams. For example, the scanning device may receive a BIG at a time point determined based on the BIGInfo field. In addition, the BIGInfo field may further include a seed access address S_AA. The PA PDU may be transmitted via one or more general-purpose channels.

The fourth FOL comprises at least one BIG. The BIG contains one or more BISes used to transport broadcast audio streams, and each BIS may carry audio data. The BIG may be transmitted via one or more general-purpose channels.

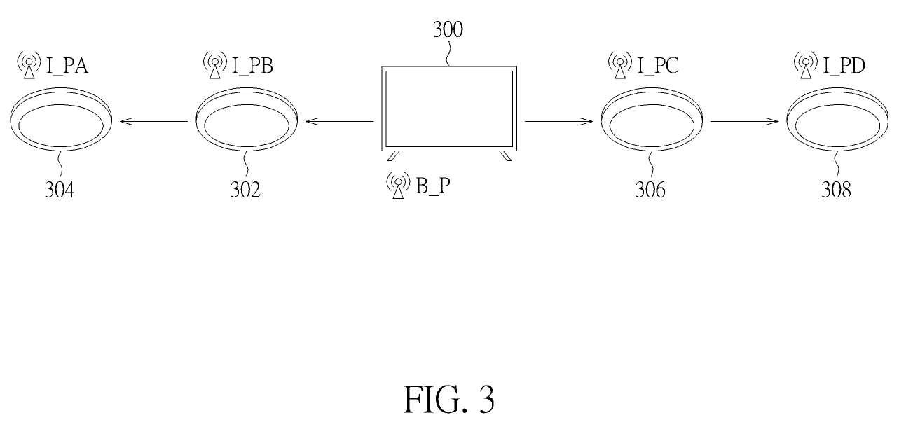

FIG. 3 is a diagram illustrating an example of broadcasting the audio broadcast transmission via an audio source device and multiple intermediate audio devices according to an embodiment of the present invention, wherein each of electronic devices 300, 302, 304, 306, and 308 may be implemented by the electronic device 10 shown in FIG. 1, the electronic device 300 supports the BMS and acts as the original audio source device, and each of the electronic devices 302, 304, 306, and 308 supports both the BMS and the BMR, and acts as an intermediate audio device.

In the beginning, the electronic device 300 may broadcast the audio broadcast transmission B_P over the air for scanning and reception by multiple reception devices within a first broadcast range. Assume that both the electronic devices 302 and 306 are located in the first broadcast range. The electronic device 302 may perform a scanning operation to receive the audio broadcast transmission B_P from the electronic device 300, and determine whether to relay the audio broadcast transmission B_P. If the determination result is to relay the broadcast transmission B_P, the electronic device 302 may transmit an intermediate audio broadcast transmission I_PB according to the audio broadcast transmission B_P within a second broadcast range. Assume that the electronic device 304 is located in the second broadcast range. The electronic device 304 may perform a scanning operation to receive the intermediate audio broadcast transmission I_PB from the electronic device 302, determine whether to relay the intermediate audio broadcast transmission I_PB, and then transmit an intermediate audio broadcast transmission I_PA according to the intermediate audio broadcast transmission I_PB within a third broadcast range if the determination result is to relay the intermediate audio broadcast transmission I_PB.

Similarly, the electronic device 306 may perform a scanning operation to receive the audio broadcast transmission B_P from the electronic device 300, and determine whether to relay the audio broadcast transmission B_P. If the determination result is to relay the broadcast transmission B_P, the electronic device 306 may transmit an intermediate audio broadcast transmission I_PC according to the audio broadcast transmission B_P within a fourth broadcast range. Assume that the electronic device 308 is located in the fourth broadcast range. The electronic device 308 may perform a scanning operation to receive the intermediate audio broadcast transmission I_PC from the electronic device 306, determine whether to relay the intermediate audio broadcast transmission I_PC, and then transmit an intermediate audio broadcast transmission I_PD according to the intermediate audio broadcast transmission I_PC within a fifth broadcast range if the determination result is to relay the intermediate audio broadcast transmission I_PC.

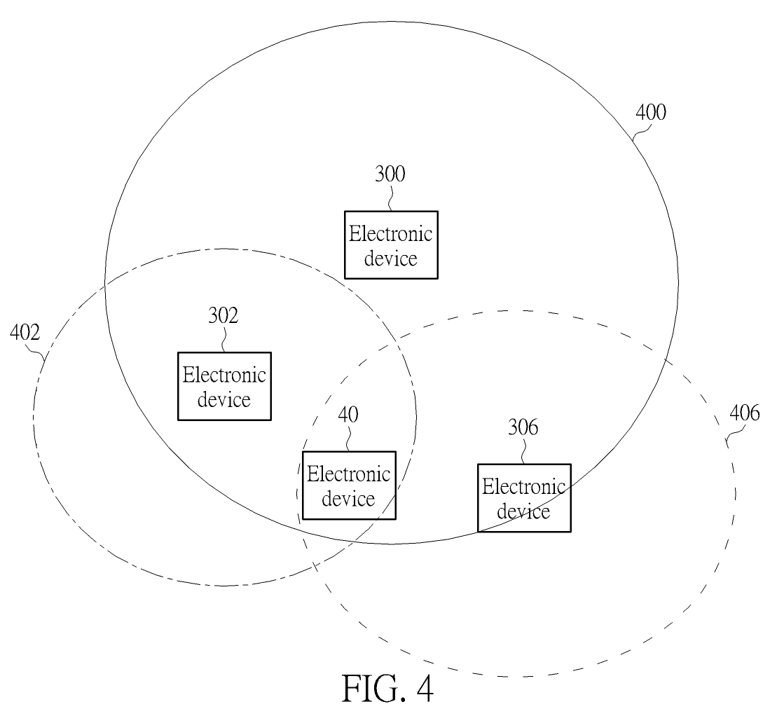

Specifically, refer to FIG. 4. FIG. 4 is a diagram illustrating multiple broadcast ranges 400, 402, and 406 of an audio source device (e.g., the electronic device 300) and multiple intermediate audio devices (e.g., the electronic devices 302 and 306) according to an embodiment of the present invention, wherein the broadcast range 400 corresponds to the electronic device 300, the broadcast range 402 corresponds to the electronic device 302, and the broadcast range 406 corresponds to the electronic device 306. As shown in FIG. 4, after the electronic device 300 broadcasts the audio broadcast transmission B_P, the electronic device 302 located in the broadcast range 400 may receive the audio broadcast transmission B_P and transmit the intermediate audio broadcast transmission I_PB according to the audio broadcast transmission B_P within the broadcast range 402. Similarly, the electronic device 306 located in the broadcast range 400 may receive the audio broadcast transmission B_P and transmit the intermediate audio broadcast transmission I_PC according to the audio broadcast transmission B_P within the broadcast range 404. At this moment, for an electronic device 40 supporting the BMR and being located in the broadcast ranges 400, 402, and 406, the electronic device 40 may be able to receive the audio broadcast transmission B_P, the intermediate audio broadcast transmission I_PB, and the intermediate audio broadcast transmission I_PC after performing the scanning operation. Some problems may occur, however. For example, the electronic device 40 is unable to determine which of the audio broadcast transmission B_P, the intermediate audio broadcast transmission I_PB and the intermediate audio broadcast transmission I_PC should be relay. So, the intermediate audio device may determine whether the receiving audio broadcast transmission or received audio broadcast transmission needs to be replayed.

The following two schemes are provided for determining whether the receiving audio broadcast transmission or received audio broadcast transmission needs to be replayed.

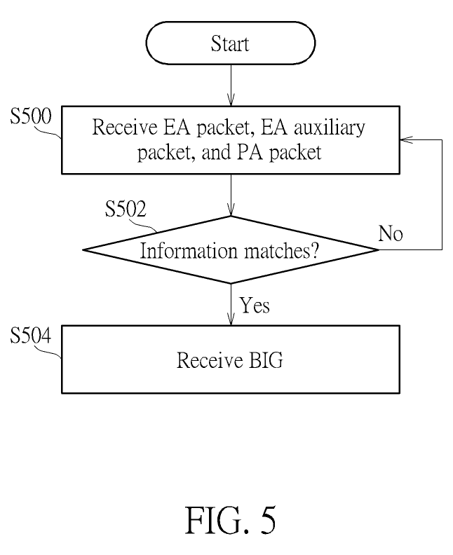

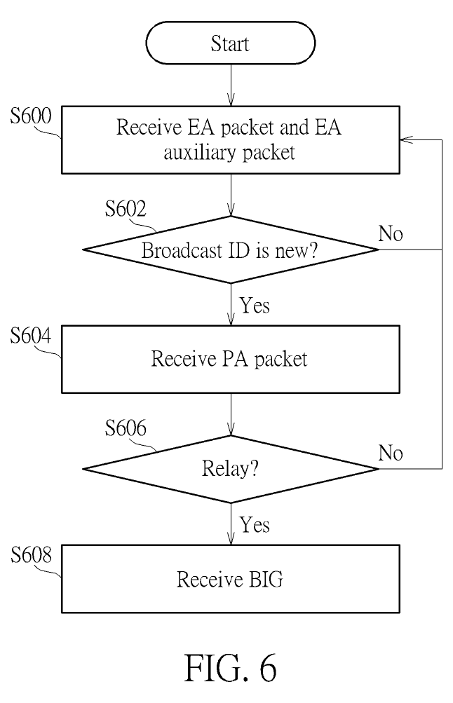

FIGS. 5 and 6 illustrate a flow chart of an intermediate device determining to relay the audio broadcast transmission and receiving the audio broadcast transmission, respectively, according to an embodiment of the present invention.

FIG. 5 shows a first scheme. In the first scheme, the intermediate audio device determines whether to relay audio broadcast transmission based on the information stored in the intermediate audio device.

In Step S500, a scanning operation is performed by the intermediate audio device to receive an EA packet, an EA auxiliary packet, and a PA packet of an audio broadcast transmission (e.g., the audio broadcast transmission B_P).

In Step S502, it is determined whether information in the EA packet, the EA auxiliary packet, or the PA packet is matched to the information stored in the intermediate audio device. If Yes, Step S504 is entered; if No, Step S500 may be entered or the intermediate audio device adopts the scheme shown in FIG. 6 to determine whether to relay the audio broadcast transmission based on the advertising data in the EA auxiliary packet and/or the advertising data in the PA packet.

Specifically, in some embodiments, a bluetooth (BT) controller in the intermediate audio device receives the EA packet and the EA auxiliary packet, and transmits an EA report to the host, wherein the EA report includes the advertising address and the EA advertising data, and the EA advertising data includes the broadcast ID and the broadcast name. The host determines whether the advertising address from the EA report matches to one device address among device addresses stored in the intermediate audio device. The host determines to relay the audio broadcast transmission when the advertising address from the EA report matches to one device address among the device addresses. The host determines not to relay the audio broadcast transmission when the advertising address from the EA report does not match to any device address among the device addresses. If the host determines not to relay the audio broadcast transmission, the host does not instruct the BT controller to receive PA packets.

In some embodiments, the BT controller in the intermediate audio device receives the EA packet, the EA auxiliary packet, and the PA packet, and transmits an EA report and a PA report to the host, wherein the EA report includes the advertising address and the EA advertising data, and the PA report includes the PA advertising data. The host determines whether some content in the EA advertising data or some content in the PA advertising data matches to stored information, and if so, the host determines to relay the audio broadcast transmission. The content in the EA advertising data that needs to be matched may include the broadcast name or a customized data, and the content in the PA advertising data that needs to be matched may include program information.

In Step S504, a BIG of the audio broadcast transmission B_P is received and synchronized.

Specifically, the intermediate audio device performs a reception to the BIG based on the BIGinfo in the PA packet. The intermediate audio device performs a synchronized reception to a first BIG in audio broadcast transmission B_P at a time point determined based on the BIGinfo. The intermediate audio device determines anchors for receiving following BIG based on the time point and interval information in the BIGinfo field.

FIG. 6 shows a second scheme. In the second scheme, the intermediate audio device determines whether to relay audio broadcast transmission based on at least one of the advertising data in the EA auxiliary packet and the advertising data in the PA packet.

In Step S600, a scanning operation is performed by the intermediate audio device to receive an EA packet and EA auxiliary packet of an audio broadcast transmission (e.g., the audio broadcast transmission B_P).

In Step S602, it is determined whether the broadcast ID carried in the EA packet of the audio broadcast transmission B_P is a new broadcast ID (labeled as “New?” in FIG. 6 for brevity). If Yes, Step 604 is entered; if No, Step S600 is entered. That is, in response to the broadcast ID not being the new broadcast ID, the scanning operation is re-performed to receive another EA packet.

In response to the broadcast ID not being the new broadcast ID, the intermediate audio device does not generate the intermediate audio broadcast transmission for the broadcast ID. Specifically, the intermediate audio device does not receive PA packet in the audio broadcast transmission based on the EA auxiliary packet, wherein the PA packet includes a BIGinfo field, and the BIGinfo field includes information for helping the intermediate audio device to perform a reception of the BIG in the audio broadcast transmission. Because the intermediate audio device does not receive PA packet in the audio broadcast transmission, the intermediate audio device does not receive the BIG carrying the audio broadcast streams.

In Step S604, a PA packet of the audio broadcast transmission B_P is received. In response to the broadcast ID being the new broadcast ID, the intermediate audio device performs a reception to the PA packet.

In Step S606, it is determined whether the audio broadcast transmission B_P needs to be relayed (labeled as “Relay?” in FIG. 6 for brevity). If Yes, Step S608 is entered; if No, Step S600 is entered. That is, in response to the audio broadcast transmission B_P not needing to be relayed, the scanning operation is re-performed to receive another EA packet.

In this step, the intermediate audio device determines whether to forward the broadcast streams based on at least one of the advertising data in the EA auxiliary packet and the advertising data in the PA packet in the audio broadcast transmission B_P. For example, the intermediate audio device displays the broadcast name in the EA advertising data in the EA auxiliary packet and the program information in the PA advertising data in the PA packet for the user of the intermediate audio device to determine whether to forward the broadcast streams in the audio broadcast transmission B_P. The electronic device 10 further receives the instruction triggered by the user for indicating whether the broadcast streams need to be forwarded.

Specifically, the BT controller in the intermediate audio device transmits an EA report to the host, wherein the EA report includes the advertising address and the EA advertising data, and the EA advertising data includes the broadcast ID and the broadcast name. The host finds the broadcast ID is new and indicates the BT controller to receive the PA packet. The BT controller receives the PA packet and sends a PA report to the host, wherein the PA report includes the PA advertising data. The host determines whether to relay the audio broadcast transmission based on the PA advertising data and the EA advertising data. For example, the host displays the broadcast name in the EA advertising data and the program information in the PA advertising data for the user to determine whether to forward the broadcast streams in the audio broadcast transmission B_P. The host may further receive the instruction triggered by the user for indicating whether the broadcast streams need to be forwarded.

In Step S608, a BIG of the audio broadcast transmission B_P is received. The BIG includes multiple BISes carrying broadcast data.

In some embodiments, the intermediate audio device plays the audio data of the audio broadcast streams to the user, and the intermediate broadcast transmission is generated or transmitted after an indication triggered by the user for indicating that the played audio data needing to be forwarded is received.

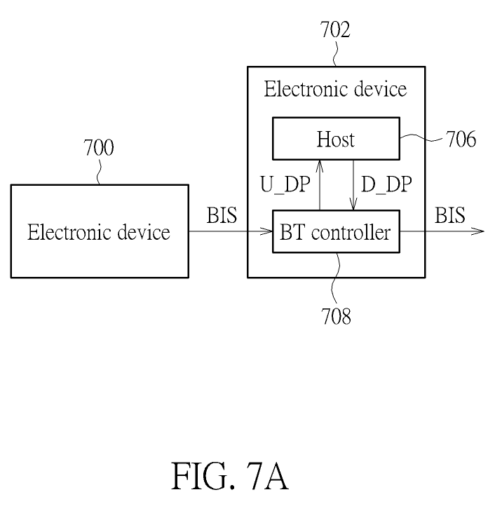

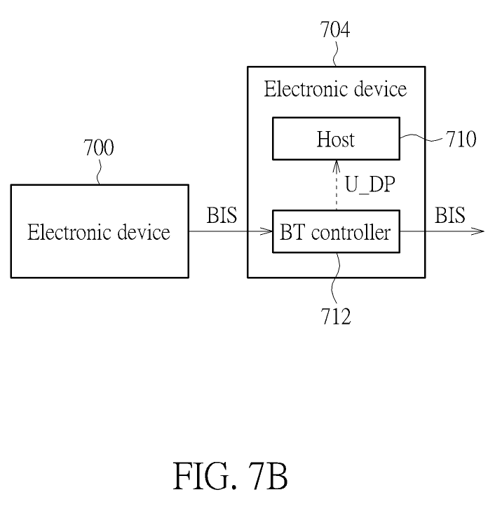

FIGS. 7A and 7B illustrate an intermediate audio device forwarding audio broadcast streams, respectively, according to an embodiment of the present invention. Each of electronic devices 700, 702, and 704 shown in FIGS. 7A and 7B may be implemented by the electronic device 10 shown in FIG. 1.

The electronic device 700 may be an audio source device and may be arranged to broadcast the audio broadcast transmission with a BIS carrying audio data over the air. The electronic device 702 may be an intermediate audio device and may include a host 706 (also referred to be a main processor) and a BT controller 708. In this embodiment, the BT controller 708 does not have a buffer for storing audio data of the BIS, and the BT controller 708 does not have a direct forwarding capability. After scanning and receiving the BIS, the BT controller 708 may transmit audio data of the BIS to the host 706 via an uplink data path U_DP, and the audio data of the BIS may be issued from the host 706 to the BT controller 708 via a downlink data path D_DP. However, the process of transmitting the audio data of the BIS to the host 706 and then issuing the audio data of the BIS from the host 706 to the BT controller 708 is quite time-consuming, which increases a latency of forwarding the audio broadcast stream.

As shown in FIG. 7B, the electronic device 700 may be an audio source device, and may be arranged to broadcast the audio broadcast transmission with a BIS carrying audio data over the air, and the electronic device 704 may be an intermediate audio device, and may include a host 710 (also referred to be a main processor) and a BT controller 712, wherein the host and 710 the BT controller 712 may be two separate chips. In this embodiment, the BT controller 712 has a buffer for storing audio data of the BIS, and the BT controller 712 has a direct forwarding capability. After receiving the BIGinfo field in the PA packet, the BT controller 712 may store the audio data of the BIS into the buffer and forward the audio data in the buffer. In this way, the audio data of the BIS will not be transmitted to the host 706, or it is not required to receive the audio data from the host 706 even if the audio data of the BIS is transmitted to the host 706. In addition, a latency of relaying an audio broadcast transmission is decreased. If the electronic device 704 needs to play the audio data of the BIS, the BT controller 712 transmits the audio data of the BIS to the host 710 via the uplink data path U_DP.

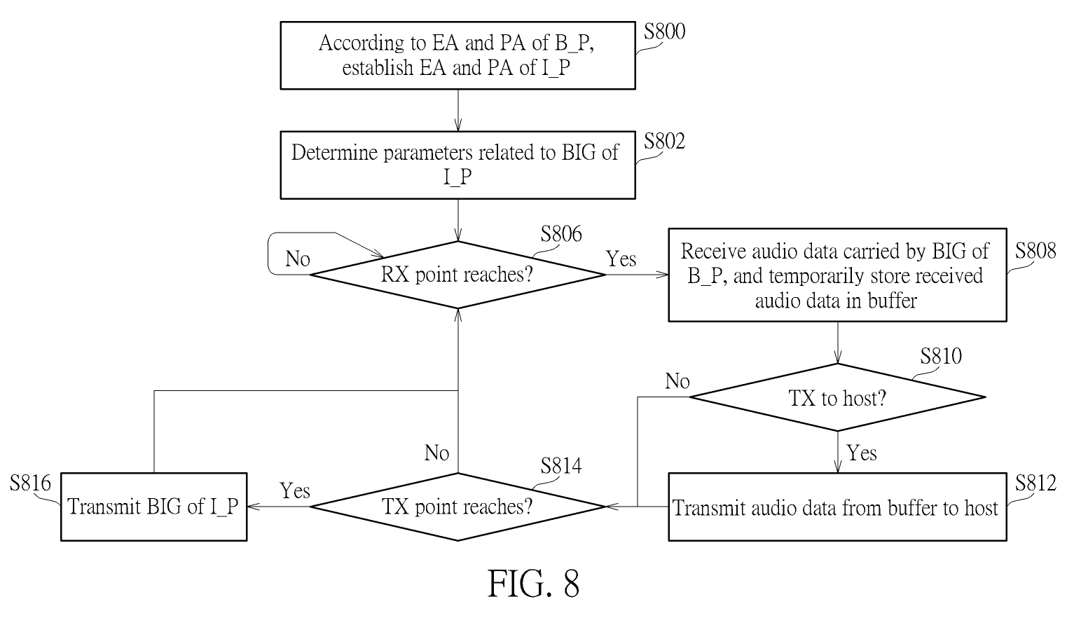

FIG. 8 illustrates a working flow of a method for forwarding an audio broadcast stream according to an embodiment of the present invention. The method shown in FIG. 8 may be employed by the electronic device 10 shown in FIG. 1, wherein the electronic device 10 supports the Auracast broadcast audio function, and may acts as both the BMS and the BMR. For better comprehension, the method may be illustrated with the working flow shown in FIG. 8, but the present invention is not limited thereto. In some embodiments, one or more steps may be added, deleted, or changed in the working flow shown in FIG. 8.

In Step S800, according to the EA packet, the EA auxiliary packet and the PA packet of the audio broadcast transmission B_P, an EA packet, an EA auxiliary packet and a PA packet of the intermediate audio broadcast transmission I_P are established and transmitted, wherein values of frequency hopping algorithm-related parameters of the intermediate audio broadcast transmission I_P are different from that of the audio broadcast transmission B_P.

In some embodiments, the EA packet and the EA auxiliary packet of intermediate audio broadcast transmission I_P are transmitted before a first BIG in the audio broadcast transmission B_P. The first BIG is the 1^{st} BIG in the BIGs carrying the audio broadcast streams.

In some embodiments, the EA packet and the EA auxiliary packet of intermediate audio broadcast transmission I_P are transmitted after a first BIG in the audio broadcast transmission B_P.

The present invention further proposes that values of frequency hopping algorithm-related parameters of the intermediate audio broadcast transmission (e.g., the intermediate audio broadcast transmission I_PB and I_PC) generated by the intermediate audio device of the present invention (e.g., the electronic devices 302 and 304) are different from that of the audio broadcast transmission B_P, for reducing the probability that the audio broadcast streams in the intermediate audio broadcast transmission I_PB occupy the same channels as the audio broadcast streams in the intermediate audio broadcast transmission I_PC and reducing the probability that the PA packets in the intermediate audio broadcast transmission I_PB occupy the same channels as the PA packets in the intermediate audio broadcast transmission I_PC. For example, the frequency hopping algorithm-related parameters includes at least one of the advertising address ADV_A, the access address A_A, and the seed access address S_AA, wherein the advertising address ADV_A is in the EA packet, and both the access address A_A and the seed access address S_AA are in the PA packet. Because advertising address ADV_A of the electronic device 302 is different from advertising address ADV_A of the electronic device 306, so both the access address A_A and the seed access address S_AA in the PA packet in the intermediate audio broadcast transmission I_PB are different from that in the PA packet in the intermediate audio broadcast transmission I_PC.

The intermediate audio device may use partial contents of advertising data, such as partial contents of the advertising data ADV_DATA_EA in the EA auxiliary packet of the audio broadcast transmission B_P and partial contents of the advertising data ADV_DATA_PA in the PA packet of the audio broadcast transmission B_P, to establish the EA auxiliary packet and the PA packet of the intermediate audio broadcast transmission, wherein the advertising data ADV_DATA_EA includes the broadcast ID. The broadcast ID included in the advertising data ADV_DATA_EA of the intermediate audio broadcast transmission is the same as that of the audio broadcast transmission B_P. In some embodiments, the broadcast name and the Public Broadcast Announcement in the EA auxiliary packet in the intermediate audio broadcast transmission is same as that in the EA auxiliary packet in the audio broadcast transmission B_P. A basic Audio Announcements in the PA packet in the intermediate audio broadcast transmission is same as that in the PA packet in the audio broadcast transmission B_P.

In Step S802, according to multiple parameters related to the BIG of the audio broadcast transmission B_P, parameters related to the BIG of the intermediate audio broadcast transmission I_P are determined, wherein the multiple parameters may be included in the basic audio announcement service UUID of the PA packet of the audio broadcast transmission B_P.

In Step S806, it is determined, by the wireless communication module 14 (e.g., the BT controller), whether a reception anchor point reaches (labeled as “RX point reaches?” in FIG. 8 for brevity). If Yes, Step S808 is entered. If No, Step S806 may be stayed until the reception anchor point reaches.

In Step S808, audio data carried by the BIS in the BIG of the audio broadcast transmission B_P is received by the wireless communication module 14, and the audio data carried by the BIS in the BIG is temporarily stored in the buffer 21 of the wireless communication module 14.

In Step S810, it is determined, by the wireless communication module 14, whether the audio data is required to be transmitted to the host 22 (labeled as “TX to host?” in FIG. 8 for brevity). If Yes, Step S812 is entered. If No, Step S814 is entered.

In one embodiment, if the host needs to play the audio data, the audio data needs to be sent to the host.

In Step S812, the audio data is obtained from the buffer 21 and transmitted to the host 22. In one embodiment, the audio data is transmitted to the host 22 before the BIG of the intermediate audio broadcast transmission I_P is transmitted.

In Step S814, it is determined, by the wireless communication module 14, whether a transmission anchor point reaches for transmitting the BIG of the intermediate audio broadcast transmission I_P (labeled as “TX point reaches?” in FIG. 8 for brevity), wherein the audio data is included in the BIG of the intermediate audio broadcast transmission I_P. If Yes, Step S816 is entered. If No, Step S806 is returned for determining whether the reception anchor point reaches again.

In Step S816, the BIG of the intermediate audio broadcast transmission I_P is transmitted, wherein the BIG of the intermediate audio broadcast transmission I_P is referred to as an intermediate BIG. In this step, the wireless communication module 14 transmits the BIG, and the BIS in the BIG carries the audio data from the buffer 21.

In some embodiments, one intermediate BIG of the intermediate audio broadcast transmission I_P is transmitted between the reception of two BIGes of the audio broadcast transmission B_P.

The above embodiments of this application are described using audio broadcast as an example. The solutions of this application are not limited to audio broadcast and are also applicable to the broadcasting of data in other formats.

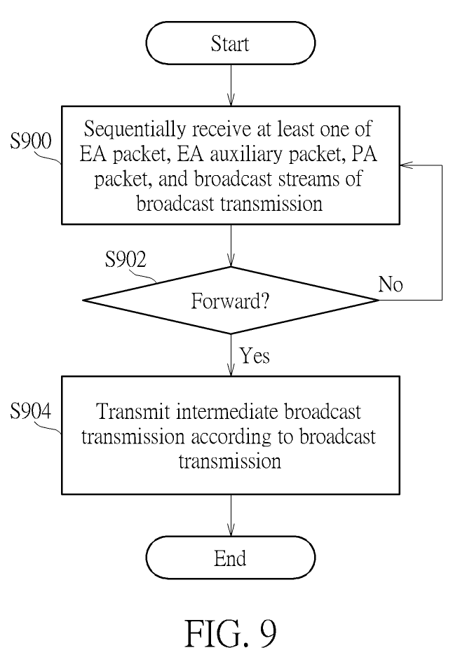

FIG. 9 is a flow chart of a method for forwarding broadcast streams by an electronic device according to an embodiment of the present invention, wherein the electronic device may be implemented by the electronic device 10 shown in FIG. 1, the electronic device 10 supports the Auracast broadcast audio function, and may acts as both the BMS and the BMR. For better comprehension, the method may be illustrated with the working flow shown in FIG. 9, but the present invention is not limited thereto. In some embodiments, one or more steps may be added, deleted, or changed in the working flow shown in FIG. 9.

In Step S900, at least one of an EA packet, an EA auxiliary packet, a PA packet, and the BISs of a broadcast transmission is sequentially received, wherein the broadcast transmission includes the EA packet, the EA auxiliary packet, the PA packet, and the BISs; and the BISs carry the broadcast streams. In this step, the EA auxiliary packet is received according to information included in the EA packet; the PA packet is received according to information included in the EA auxiliary packet; and the BISs are received according to the information included in the PA packet.

In Step S902, it is determined whether the broadcast streams need to be forwarded based on at least one of the EA packet, the EA auxiliary packet, and the PA packet (labeled as “Forward?” in FIG. 9 for brevity). If Yes, Step S904 is entered; if No, Step S900 is returned.

In Step S904, in response to the broadcast streams needing to be forwarded, an intermediate broadcast transmission is transmitted according to the broadcast transmission, wherein the intermediate broadcast transmission includes an intermediate EA packet, an intermediate EA auxiliary packet, an intermediate PA packet, and intermediate BISs carrying the broadcast streams.

In summary, for the electronic device of the present invention acting as both the BMS and BMR (e.g., an intermediate audio device), the electronic device may relay the received audio broadcast transmission or the receiving audio broadcast transmission. Further, the wireless communication module (e.g., the BT controller) in the electronic device can directly forward the audio data of the received audio broadcast transmission without sending the audio data to the host and then forwarding the audio data from the host, which can greatly improve a latency of forwarding the audio broadcast streams.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for forwarding broadcast streams by an electronic device, comprising:
receiving at least one of an extended advertising (EA) packet, an EA auxiliary packet, a periodic advertising (PA) packet, and broadcast isochronous streams (BISs) of a broadcast transmission, wherein the broadcast transmission comprises the EA packet, the EA auxiliary packet, the PA packet, and the BISs; and the BISs carry the broadcast streams;
determining whether the broadcast streams need to be forwarded based on at least one of the EA packet, the EA auxiliary packet, and the PA packet; and
in response to the broadcast streams needing to be forwarded, transmitting an intermediate broadcast transmission according to the broadcast transmission, wherein the intermediate broadcast transmission comprises an intermediate EA packet, an intermediate EA auxiliary packet, an intermediate PA packet, and intermediate BISs carrying the broadcast streams.

2. The method of claim 1, wherein the step of determining whether the broadcast streams need to be forwarded based on the at least one of the EA packet, the EA auxiliary packet, and the PA packet comprises:
determining whether a broadcast identification (ID) carried in the EA auxiliary packet is a new broadcast ID;
in response to the broadcast ID being the new broadcast ID, determining whether the broadcast streams of the broadcast transmission need to be forwarded based on at least one of advertising data in the EA auxiliary packet and advertising data in the PA packet.

3. The method of claim 2, wherein the step of determining whether the broadcast streams of the broadcast transmission need to be forwarded based on the at least one of the advertising data in the EA auxiliary packet and the advertising data in the PA packet comprises:
determining whether the broadcast streams need to be forwarded based on at least one of a broadcast name in the EA auxiliary packet and program information in the PA packet.

4. The method of claim 1, wherein the step of determining whether the broadcast streams need to be forwarded based on the at least one of the EA packet, the EA auxiliary packet, and the PA packet comprises:
determining whether an advertising address in the EA packet matches to one of device addresses stored in the electronic device; and
in response to the advertising address matching to the one of the device addresses stored in the electronic device, determining that the broadcast streams need to be forwarded.

5. The method of claim 1, wherein the step of determining whether the broadcast streams need to be forwarded based on the at least one of the EA packet, the EA auxiliary packet, and the PA packet comprises:
determining whether certain content in advertising data in the EA packet or certain content in advertising data in the PA packet matches to information stored in the electronic device; and
in response to the certain content in the advertising data in the EA packet or the certain content in the advertising data in the PA packet matching to the information stored in the electronic device, determining that the broadcast streams need to be forwarded.

6. The method of claim 1, wherein a value of a frequency hopping algorithm-related parameter of the intermediate broadcast transmission is different from a value of a frequency hopping algorithm-related parameter of the broadcast transmission.

7. The method of claim 6, wherein the frequency hopping algorithm-related parameter comprises at least one of an advertising address in corresponding broadcast transmission, a seed access address in the corresponding broadcast transmission, and an access address in the corresponding broadcast transmission.

8. The method of claim 1, wherein the broadcast streams are audio broadcast streams, and the method further comprises:
playing audio data of the audio broadcast streams before transmitting an intermediate broadcast transmission;
wherein the intermediate broadcast transmission is transmitted after an indication indicating that the audio data needing to be forwarded is received.

9. The method of claim 2, further comprising:
in response to the broadcast ID not being the new broadcast ID, not generating the intermediate broadcast transmission according to the broadcast transmission.

10. The method of claim 9, further comprising:
in response to the broadcast ID not being the new broadcast ID, not receiving the PA packet of the broadcast transmission, wherein the PA packet comprises a BIGinfo field; the BIGinfo field comprises information for helping the electronic device to perform a reception of at least one broadcast isochronous group (BIG) comprised in the broadcast transmission; and the at least one BIG comprises one or more BISs carrying the broadcast streams.

11. The method of claim 2, further comprising:
in response to the broadcast ID being the new broadcast ID, performing a reception of the PA packet of the broadcast transmission; and
performing a reception of at least one broadcast isochronous group (BIG) of the broadcast transmission based on information in the PA packet, wherein one or more BISs carrying the broadcast streams are comprised in the at least one BIG.

12. The method of claim 1, wherein the electronic device comprises a bluetooth (BT) controller and a host, the intermediate broadcast transmission comprises at least one intermediate broadcast isochronous group (BIG), the at least one BIG comprises one or more BISs carrying the broadcast streams, and the step of in response to the broadcast streams needing to be forwarded, transmitting the intermediate broadcast transmission according to the broadcast transmission comprises:
transmitting data of the broadcast streams from the BT controller to the host;
receiving the data from the host;
transmitting the at least one intermediate BIG of the intermediate broadcast transmission, wherein BISs in the at least one intermediate BIG of the intermediate broadcast transmission carry the data from the host.

13. The method of claim 1, wherein the electronic device comprises a bluetooth (BT) controller and a host, and the intermediate broadcast transmission comprises at least one intermediate broadcast isochronous group (BIG), the at least one intermediate BIG comprises one or more BISs carrying the broadcast streams, and the step of in response to the broadcast streams needing to be forwarded, transmitting the intermediate broadcast transmission according to the broadcast transmission comprises:
storing data of the broadcast streams of the broadcast transmission into a buffer;
transmitting the at least one intermediate BIG of the intermediate broadcast transmission, wherein BISs in the at least one intermediate BIG of the intermediate broadcast transmission carry the data stored in the buffer.

14. The method of claim 1, wherein the broadcast streams are carried in BISs of at least one broadcast isochronous group (BIG) in the broadcast transmission, the broadcast streams are carried in BISs of at least one intermediate BIG in the intermediate broadcast transmission, and one intermediate BIG among the at least one intermediate BIG is transmitted between reception of two BIGes among the at least one BIG.

15. The method of claim 1, wherein the broadcast streams are carried in BISs of at least one broadcast isochronous group (BIG) in the broadcast transmission, and the intermediate EA packet and the intermediate EA auxiliary packet are transmitted before a first BIG among the at least one BIG is received.

16. The method of claim 1, wherein the broadcast streams are carried in BISs of at least one broadcast isochronous group (BIG) in the broadcast transmission; and the intermediate EA packet, the intermediate EA auxiliary packet, and the intermediate PA packet are transmitted before a first BIG among the at least one BIG is received.

17. An electronic device, comprising:
a wireless communication module, arranged to perform a scanning operation to receive at least one of an extended advertising (EA) packet, an EA auxiliary packet, a periodic advertising (PA) packet, and broadcast isochronous streams (BISs) of a broadcast transmission, wherein the broadcast transmission comprises the EA packet, the EA auxiliary packet, the PA packet, and the BISs; and the BISs carry the broadcast streams; and
a processor, arranged to:
determine whether the broadcast streams need to be forwarded based on at least one of the EA packet, the EA auxiliary packet, and the PA packet;
wherein in response to the broadcast streams needing to be forwarded, the wireless communication module is further arranged to transmit an intermediate broadcast transmission according to the broadcast transmission; and the intermediate broadcast transmission comprises an intermediate EA packet, an intermediate EA auxiliary packet, an intermediate PA packet, and intermediate BISs carrying the broadcast streams.

18. The electronic device of claim 17, wherein the processor is further arranged to determine whether a broadcast identification (ID) carried in the EA auxiliary packet is a new broadcast ID, and determine whether the broadcast streams of the broadcast transmission need to be forwarded based on at least one of advertising data in the EA auxiliary packet and advertising data in the PA packet in response to the broadcast ID being the new broadcast ID.

19. The electronic device of claim 18, wherein in response to the broadcast ID not being the new broadcast ID, the PA packet of the broadcast transmission is not received; the PA packet comprises a BIGinfo field; the BIGinfo field comprises information for helping the electronic device to perform a reception of at least one broadcast isochronous group (BIG) comprised in the broadcast transmission; and the at least one BIG comprises one or more BISs carrying the broadcast streams.

20. The electronic device of claim 17, wherein the wireless communication module is further arranged to store data of the broadcast streams of the broadcast transmission into a buffer, and transmit at least one intermediate broadcast isochronous group (BIG) of the intermediate broadcast transmission; and BISs in the at least one intermediate BIG of the intermediate broadcast transmission carry the data stored in the buffer.
